(19) United States
(12) Patent Application Publication
(10) Pub. No.: US 2019/0388719 A1
(43) Pub. Date: Dec. 26, 2019

(54) DRY SPRINKLER SYSTEM MANIFOLD ADAPTER

(71) Applicant: GLOBE FIRE SPRINKER CORPORATION, Standish, MI (US)

(72) Inventors: Stephen J. MEYER, Chester Springs, PA (US); Thomas Edwin ARCHIBALD, Midland, MI (US); Kevin Desmond MAUGHAN, North Kingstown, RI (US); John DESROSIER, Plymouth, MA (US); Gordon FARRELL, North Conway, NH (US)

(21) Appl. No.: 16/481,182

(22) PCT Filed: Jan. 25, 2018
(86) PCT No.: PCT/US18/15131

§ 371 Date: Jul. 26, 2019

Related U.S. Application Data
(60) Provisional application No. 62/451,244, filed on Jan. 27, 2017.

(51) Int. Cl. A62C 35/62; A62C 35/64; F16K 1/22

(52) U.S. Cl. CPC A62C 35/62; A62C 35/68; F16K 1/221; A62C 35/645

(57) ABSTRACT

A manifold assembly is mountable to a piping manifold for a dry sprinkler system having a non-wet valve assembly separating pressurized gas on a downstream side thereof from a water supply on an upstream side thereof. The manifold assembly includes a single piece body having an inlet for removably coupling to, and receiving water from, an upstream wet standpipe, and an outlet for removably coupling to, and delivering water to, the non-wet valve assembly. A control valve assembly is mounted to the body and a mechanically independent flow detection switch is mounted to the body. Each of a test and drain valve and a pressure relief valve is fluidly connected with the body downstream of the control valve assembly and upstream of the

### CROSS-REFERENCE TO RELATED APPLICATIONS

This application claims priority from U.S. Provisional Patent Application No. 62/451,244, titled “Dry Sprinkler System Manifold Adapter”, filed on Jan. 27, 2017, the entire contents of which are incorporated by reference herein.

### BACKGROUND OF THE INVENTION

The present invention is generally directed to a manifold adapter for a sprinkler system, and more particularly to a manifold adapter for a dry sprinkler system used to control and monitor water released to downstream sprinkler heads.

Fire suppression sprinkler systems designed for protection of commercial and non-commercial properties include some combination or all of a control valve, a check valve, a water flow detection switch, a test and drain system and a pressure relief valve. The control valve is required to control shutting off the water flow to the sprinklers downstream thereof, e.g., for maintenance purposes. The flow detection switch is required at least to sound an alarm when the sprinklers are activated. The test and drain system is required for testing of the sprinkler system and also for draining the sprinkler system, e.g., also for maintenance purposes. The pressure relief valve is required to ensure that the water pressure within the sprinkler system does not surpass a safe level.

In areas subject to freezing temperatures, water in the wet pipes is likely to freeze, resulting in costly damage to the sprinkler system, such as pipe bursting. A dry system is, therefore, generally considered for areas where the temperature cannot be maintained above 40° F. In a dry system, sprinkler heads are attached to a piping system containing pressurized gas, e.g., air or nitrogen, in lieu of water. The check valve in a dry system, i.e., a non-wet valve, is a valve that separates the pressurized gas on the downstream side thereof from the water supply on the upstream side thereof. The supply-side piping system up to the non-wet valve assembly, and associated equipment, is installed within a heated environment (or at least an environment not subject to freezing temperatures) to prevent freezing. The piping network downstream of the non-wet valve to the sprinkler heads extends in the cold environment.

In operation, the pressurized gas maintains the non-wet valve in a closed position when the sprinkler heads are closed, according to a pressure differential across the valve. Upon release of the pressurized gas downstream of the non-wet valve, e.g., from the opening of one or more sprinkler heads, the water pressure upstream of the non-wet valve pushes the valve open, flows through the dry portion of the system and to the open sprinkler heads.

Conventional dry pipe sprinkler systems utilize a pressure actuated water flow detection switch, e.g., a PS-10 series pressure actuated switch manufactured by Potter, for sounding an alarm upon detection of a waterflow condition in the dry portion of the system. The pressure actuated water flow detection switch is not directly mounted to the water flow piping manifold. Rather, the flow switch is fluidly connected with the water flow piping manifold via an intricate and complicated plumbing network extending from an intermediate chamber located in the non-wet valve assembly. In part due to the plumbing network for the pressure actuated flow detection switch, the piping for a dry sprinkler system has a complex and relatively large footprint, is costly to manufacture and is both time consuming, complicated and costly to assemble. Nonetheless, pressure actuated water flow detection switches continue to be utilized in dry sprinkler systems because the National Fire Protection Agency does not allow vane-type water flow detection switches mounted directly on the dry side of the system. This is because when the non-wet valve opens, water rushes in with such force that the paddle of the vane-type flow switch may be damaged, e.g., detached from the flow switch.

Therefore, it would be advantageous to manufacture a manifold adapter for a dry sprinkler system, having a compact footprint, with a control valve, a flow detection switch, a test and drain, and a pressure relief module, or some combination thereof, mounted directly thereto, thereby eliminating the complex portions of the manifold piping and the associated footprint, as well as minimizing the cost and time of manufacture and complex assembly thereof.

### BRIEF SUMMARY OF THE INVENTION

Briefly stated, one aspect of the present invention is directed to a manifold assembly mountable to a piping manifold for a dry sprinkler system having a non-wet valve assembly separating pressurized gas on a downstream side thereof from a water supply on an upstream side thereof. The manifold assembly comprises a single piece body having an inlet for removably coupling to, and receiving water from, an upstream wet standpipe, and an outlet for removably coupling to, and delivering water to, the non-wet valve assembly. A control valve assembly is mounted to the body and a mechanically independent flow detection switch is mounted to the body. The manifold assembly further comprises a test and drain valve and a pressure relief valve, each being fluidly connected with the body downstream of the control valve assembly and upstream of the outlet.

Another aspect of the present invention is directed to a manifold assembly mountable to a piping manifold for a dry sprinkler system having a non-wet valve assembly separating pressurized gas on a downstream side thereof from a water supply on an upstream side thereof. The manifold assembly comprises a control valve assembly for fluidly connecting with an upstream wet standpipe and a body having an inlet for removably coupling to, and receiving water from, the control valve assembly, and an outlet for removably coupling to, and delivering water to, the non-wet valve assembly. A mechanically independent flow detection switch is mounted to the body. The manifold assembly further comprises a test and drain valve and a pressure relief valve, each coupled to the valve body downstream from the flow detection switch.

Another aspect of the present invention is directed to a non-wet valve assembly mountable to a piping manifold for a dry sprinkler system, between pressurized gas on a downstream side thereof and water supply on an upstream side thereof. The non-wet valve assembly comprises a throat defining a monolithic extension of an upstream side of the non-wet valve assembly, the throat having an inlet for removably coupling to, and receiving water from, a control valve assembly. A mechanically independent flow detection switch is mounted to the throat. Each of a test and drain valve and a pressure relief valve is coupled to the throat downstream from the flow detection switch.

### BRIEF DESCRIPTION OF THE DRAWINGS

The following detailed description of preferred embodiments of the invention will be better understood when read in conjunction with the appended drawings. It should be understood, however, that the invention is not limited to the precise arrangements and instrumentalities shown. In the drawings:

FIG. 1 is a perspective front and side view of a single piece dry sprinkler system manifold adapter according to a first embodiment of the present invention;

FIG. 2 is a front elevational view of the single piece dry sprinkler system manifold adapter of FIG. 1;

FIG. 3 is a cross-sectional view of the single piece dry sprinkler system manifold adapter of FIG. 1, taken along the sectional line A-A of FIG. 2;

FIG. 4 is a perspective front and side view of a multiple piece dry sprinkler system manifold adapter according to a second embodiment of the present invention; and

FIG. 5 is a perspective front and side view of a dry sprinkler system manifold according to a third embodiment of the present invention.

### DETAILED DESCRIPTION OF THE INVENTION

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the manifold adapter, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

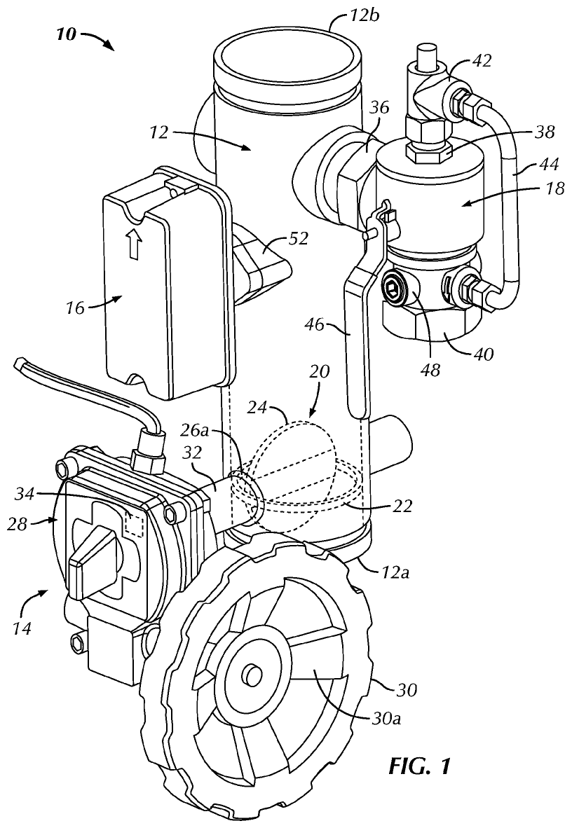

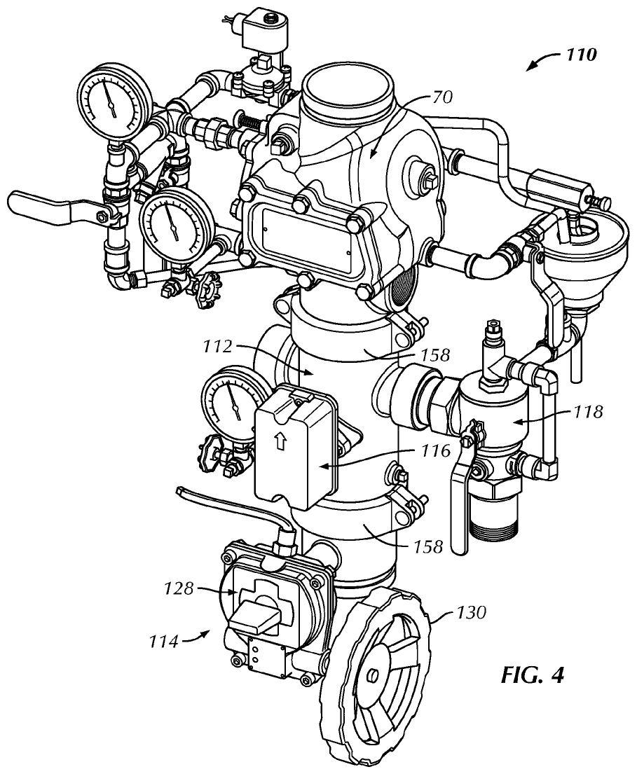

Referring to the drawings in detail, wherein like numerals indicate like elements throughout, there is shown in FIGS. 1-3 a manifold adapter, generally designated 10, in accordance with a first preferred embodiment of the present invention. The manifold adapter 10 is mountable to a piping manifold for a dry sprinkler system, between a non-wet valve assembly 70 (FIG. 4), e.g., a pre-action valve, a deluge valve, or another non-wet valve, and a wet standpipe (not shown).

The manifold adapter 10 comprises a generally tubular, single piece, e.g., integral, unitary and monolithic, body 12 having a control valve assembly 14, a mechanically independent vane-type flow detection switch 16 and a test, drain, and pressure relief module 18 mounted thereto. As should be understood, the control valve assembly 14 controls manual shut-off of the wet portion of the sprinkler system for maintenance purposes or to turn off water flow to the sprinkler heads (not shown) once a fire event is extinguished. As also should be understood by those of ordinary skill in the art, aside from closing the sprinkler system for maintenance purposes the control valve assembly 14 should generally be fully open at all times in order to ensure water flow readiness to the sprinkler heads in the event of an emergency.

The body 12 defines an inlet 12a of the manifold adapter 10 at a base end thereof (according to the orientation depicted in the Figs.), for coupling to, and receiving water from, an upstream wet standpipe (not shown). The body 12 also defines an outlet 12b of the manifold adapter 12 at an uppermost end thereof (according to the same orientation), for coupling and delivering water to the downstream non-wet valve assembly 70. In the illustrated embodiment, both ends 12a, 12b have respective outer peripheral grooves for mating in a conventional fashion with the wet standpipe and the non-wet valve assembly, respectively. Alternatively, the ends 12a, 12b could be threaded, flanged or the like for other types of conventional mating.

In the illustrated embodiments, the control valve assembly 14 comprises a butterfly control valve 20 within the body 12, having an endless, e.g., annular, seal 22 and an operatively associated butterfly valve disk 24. The annular seal 22 functions as a valve seat for the butterfly disk 24 when rotated into a closed position thereof. The term “butterfly valve,” as used herein, is sufficiently broad to cover any valve having a generally disk-shaped closure that is pivotable about an axis along a cross-section of a pipe, i.e., perpendicular to the direction of fluid flow, to regulate fluid flow.

Openings 26a and 26b are oppositely provided in the sidewall of the body 12, and sealingly receive components of a valve actuation assembly indicated generally at 28. The valve actuation assembly 28 includes a hand wheel 30 (located outside of the body 12) having a plurality of spokes 30a, operatively connected with the butterfly disk 24 (located inside the body 12) in a conventional manner, e.g., via a control arm 32. As should be understood by those of ordinary skill in the art, the butterfly disk 24 is rotatable about an axis across the diameter of the body 12 between a closed position (FIG. 3) (the disk 24 being oriented perpendicular to the direction of fluid flow through the body 12), substantially preventing fluid flow through the body 12, and an open position (FIG. 1) (the disk 24 being oriented generally parallel or non-perpendicularly to the direction of fluid flow through the body 12), permitting fluid flow through the body 12.

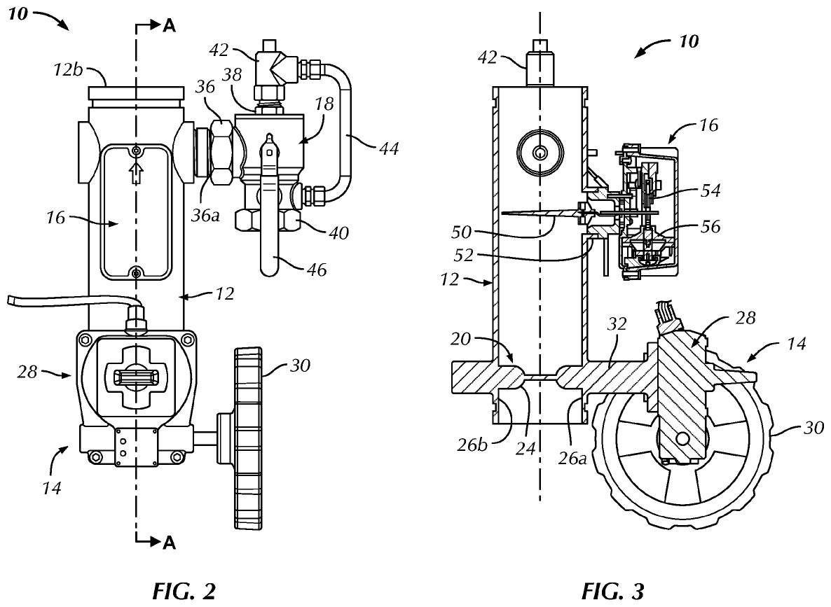

Clockwise and counterclockwise rotation of the hand wheel 30 pivots the butterfly valve disk 24 between the open and closed positions thereof (in a manner well understood by those of ordinary skill in the art) corresponding to open and closed configurations of the control valve assembly 14, respectively. Accordingly, to manually shut-off the sprinkler system, e.g., for maintenance purposes or to shut off water flow to turn the sprinkler heads after a fire event is extinguished, a user rotates the hand wheel 30 to rotate the butterfly valve disk 24 into the closed position thereof (FIG. 1). To return the sprinkler system into the normal operating condition thereof (FIGS. 2, 3), the user rotates the hand wheel 30 in the opposite direction to rotate the butterfly valve disk 24 back to the open position thereof.

Optionally, the valve actuation assembly 28 may further include a conventional, commercially available, worm gear transmission (not-shown) between the valve hand wheel 30 and the control arm 32 controlling rotation of the butterfly disk 24, to provide a reduction ratio. As should be understood, a worm gear transmission provides the necessary mechanical advantage to manually open and close the butterfly valve 20 under the operating pressure thereof. The control valve assembly 14 is also provided in a conventional fashion with one or more internal supervisory switches 34, i.e., a tamper evident switch, which operate(s) in a manner well understood by those of ordinary skill in the art, and which is operatively connected to the control valve assembly 14 in a conventional manner. The supervisory switch 34 is also connected in a manner well understood by those of ordinary skill in the art to a monitoring system (not shown), which produces a warning signal to energize an alarm, turn on a light, or the like in the event an unauthorized person starts to open or close the control valve assembly 14.

Turning to the test, drain and pressure relief module 18, the test, drain and pressure relief features are combined into a single unit, fluidly connected with the body 12 downstream of the control valve assembly 14 and upstream of the outlet 12b in the illustrated embodiment. Combining the test, drain and pressure relief systems into a single module 18 eliminates the need for an additional piping manifold, extending from the wet standpipe, for separately mounting the test valve, the drain valve and the pressure relief valve thereto. Therefore, the footprint of the sprinkler system is greatly reduced with the elimination of the piping manifold for separate test, drain and pressure relief connections, as well as the associated time, cost and complexity of assembly. As should be understood by those of ordinary skill in the art, however, the test, drain and pressure relief valves may nonetheless be separately and removably attached to the body 12. As a further alternative, one or more of the test, drain and pressure relief valves may be separately attached to the sprinkler system, in a conventional manner, such as, for example, by being mounted to the non-wet valve assembly 70 (not shown).

In the illustrated embodiment, and as shown in FIGS. 1 and 2, the module 18 includes three fluidly connectable ports 36, 38, 40 and an internal flow valve (not shown), which directs the flow between the three ports. In one embodiment, the internal flow valve may take the form of a ball valve, but is not so limited, and may alternatively take the form of any valve currently known, or that later becomes known, capable of performing the functions of the internal flow valve described herein, such as, for example, without limitation, a spool valve (not shown).

The first port 36 of the module 18 (labeled “test” in FIGS. 1, 2) is fluidly connected at an inlet side 36a thereof to the body 12, and operates as the inlet port for the module 18. A pressure relief valve 42 is mounted on the second port 38 (labeled “off” in FIGS. 1, 2). A discharge pipe 44 branches off of the pressure relief valve 42 and is fluidly connected with the third port 40 for pressure relief. The third port 40 (labeled “drain” in FIG. 1) fluidly connects the first port 36 with a drainage pipe (not shown), and operates as the exit port for the module 18. A lever 46 controls the internal flow valve.

When the lever 46 is oriented in the “test” position (not shown), the internal ball valve is oriented to be partially open or restricted between the first and third ports 36, 40, and fully closed to the second port 38. Accordingly, water from the body 12 flows into the module 18 from the first port 36 in a restricted manner and exits the module 18 through the third port 40. A transparent window 48 allows a user to see whether water is flowing into the third port 46. As should be understood, the “test” position is utilized to check whether water is present in the body 12 as required.

When the lever 46 is oriented in the “drain” position (not shown), the internal flow valve is oriented to be fully open between the first and third ports 36, 40, and fully closed to the second port 38. Accordingly, water drains out from the body 12 and into the module 18 in an unrestricted manner via the first port 36 and exits the module 18 through the third port 40. The drain position is utilized to drain water on a respective floor, e.g., for maintenance.

During normal operation, the lever 46 is oriented in the “off position” (FIG. 1). When the lever 46 is oriented in the “off” position, the internal flow valve is oriented to be fully open between the first port 36 and the second port 38, and fully closed to the third port 40. The pressure relief valve 42, mounted to the second port 38, is generally set to a threshold pressure of approximately 175 psi under normal operation. Therefore, if the pressure within the body 12 exceeds 175 psi, the pressure relief valve 42 opens and releases water through the discharge pipe 44 to the drain port 40 until the pressure falls to less than 175 psi. A general purpose of the pressure relief valve is to allow the ability to maintain appropriate water pressure at the top floors of a building without over pressurizing the bottom floors of the building.

Turning to the flow detection switch 16, the vane-type flow detection switch 16 is removably mounted to the body 12 between the test, drain and pressure relief module 18 and the control valve 14. Alternatively, in another configuration (not shown), the flow detection switch 16 may be removably mounted to the body 12 upstream of the control valve 14 (i.e., below the control valve 14 in the illustrated orientation). Mounting of a vane-type flow detection switch in the wet portion of a dry sprinkler system is permissible under the guidelines of the National Fire Protection Agency.

The flow detection switch 16 is mechanically independent of any valve within the dry sprinkler system, i.e., the flow detection switch 16 is not mechanically coupled or linked to any valve within the dry sprinkler system, and opening or closing of any valve within the dry sprinkler system does not mechanically actuate the flow detection switch 16. As shown best in FIG. 3, the flow detection switch 16 is actuated by a lever arm 50 extending from the flow detection switch 16, through a port 52 and into the interior of the body 12. The lever arm 50 extends along a plane substantially perpendicular to the direction of water flow within the body 12. A rear end of the lever arm 50 contacts an electric switch 54 which is connected with an alarm system (not shown). Water flow through body 12, across the lever arm 50, such as, without limitation, when the non-wet valve (which is not mechanically linked to the lever arm 50) opens, moves, i.e., pivots, the lever arm 50 and activates the switch 16 and sounds an alarm in a manner well understood by those of ordinary skill in the art.

The flow detection switch 16 includes an adjustable time delay 56, which is set to a predetermined period of time during which the switch 16 must remain in the activated state prior to sounding an alarm, indicating that either the sprinklers are activated or that the test, drain and pressure relief module 18 is draining water out of the body 12. The time delay accounts for sporadic and temporary pressure surges in the standpipe, without the sprinklers or the test, drain and pressure relief module 18 actually being activated. As should be understood by those of ordinary skill in the art, however, the flow detection switch 16 is not limited to a lever-actuated flow detection switch. For example, without limitation, the flow detection switch 16 may take the form of a magnetically-actuated flow detection switch (not shown) triggered by magnetic detection of movement of the non-wet valve or the test, drain and pressure relief module 18, a pressure actuated water flow detection switch, and the like.

Advantageously, the manifold adapter 10, connecting the wet standpipe (not shown) with the non-wet valve 70 and having a vane-type flow detection switch 16 and a test, drain and pressure relief module 18 directed mounted thereto, greatly reduces the piping network of a dry sprinkler system.

FIG. 4 illustrates a second embodiment of the manifold adapter 110. The reference numerals of the present embodiment are distinguishable from those of the above-described embodiment by a factor of one-hundred (100), but otherwise indicate the same elements as indicated above, except as otherwise specified. The manifold adapter 110 of the present embodiment is substantially similar to that of the earlier embodiment. Therefore, the description of certain similarities between the embodiments may be omitted herein for the sake of brevity and convenience, and, therefore, is not limiting.

A primary difference between the manifold adapters 10 and 110 is that the body 112 of the manifold adapter 110 takes the form of a separate spool pipe, fluidly connected in-line between the downstream non-wet valve assembly 70 and the upstream control valve assembly 114. As shown in FIG. 4, the flow detection switch 116 is mounted to the spool pipe body 112 in like manner as described with respect to the manifold adapter 10. Likewise, the test, drain and pressure relief module 118 is mounted to the spool pipe body 112, downstream of the flow detection switch 116, in like manner as described with respect to the manifold adapter 10. In the illustrated embodiment, the upstream (lower) end of the spool pipe body 112 is connected with the control valve assembly 114 via a mechanical coupling 158, and the downstream (upper) end of the spool pipe body 112 is connected with the non-wet valve assembly 70 via another mechanical coupling 158. As should be understood, however, the spool pipe body 112 may be connected to the non-wet valve assembly 70 and the control valve assembly 114 in any conventional manner known by those of ordinary skill in the art.

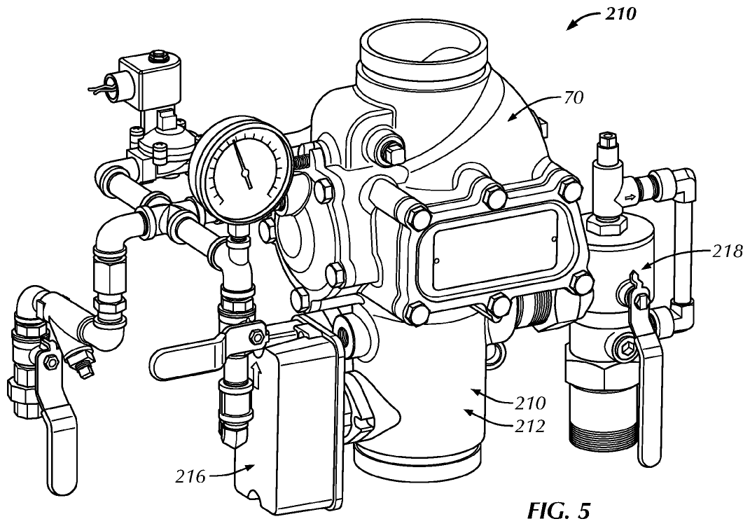

FIG. 5 illustrates a third embodiment of the manifold adapter 210. The reference numerals of the present embodiment are distinguishable from those of the above-described embodiment by a factor of two-hundred (200), but otherwise indicate the same elements as indicated above, except as otherwise specified. The manifold adapter 210 of the present embodiment is substantially similar to that of the earlier embodiment. Therefore, the description of certain similarities between the embodiments may be omitted herein for the sake of brevity and convenience, and, therefore, is not limiting.

A primary difference between the manifold adapters 10, 110 and 210 is that the manifold adapter 210 takes the form of an extension of the throat of the non-wet valve assembly 70. That is, the body 212 of the manifold adapter 210 is an integral, unitary and monolithic extension of the upstream side of the non-wet valve assembly 70. Similarly to the body 112, the flow detection switch 216 and the test, drain and pressure relief module 218 are mounted to the body 212 in like manner as described with respect to the manifold adapter 10, the module 218 being mounted downstream of the flow detection switch 216. The body 212 is connected to the control valve assembly (not shown) at an upstream end thereof, in like manner as described with respect to the manifold adapter 110.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention, as set forth in the appended claims.

We claim:

1. A manifold assembly mountable to a piping manifold for a dry sprinkler system having a non-wet valve assembly separating pressurized gas on a downstream side thereof from a water supply on an upstream side thereof, the manifold assembly comprising:
a single piece body having an inlet for removably coupling to, and receiving water from, an upstream wet standpipe, and an outlet for removably coupling to, and delivering water to, the non-wet valve assembly;
a control valve assembly mounted to the body;
a mechanically independent flow detection switch mounted to the body; and
a test and drain valve and a pressure relief valve, each being fluidly connected with the body downstream of the control valve assembly and upstream of the outlet.

2. The manifold assembly of claim 1, wherein the control valve assembly comprises a butterfly control valve within the body having an endless seal and an operatively associated butterfly valve disk, the butterfly valve disk being rotatable about an axis extending generally perpendicular to water flowing from the inlet to the outlet of the body between a closed position, substantially preventing fluid flow through the body, and an open position, permitting fluid flow through the body.

3. The manifold assembly of claim 2, further comprising a valve actuation assembly having a hand wheel operatively connected with the butterfly valve disk via a control arm.

4. The manifold assembly of claim 1, wherein the test and drain valve and the pressure relief valve are combined into a single module.

5. The manifold assembly of claim 1, wherein the flow detection switch is mounted to the body upstream of the test and drain valve and the pressure relief valve.

6. The manifold assembly of claim 5, wherein the flow detection switch is mounted to the body downstream of the control valve.

7. The manifold assembly of claim 5, wherein the flow detection switch is mounted to the body upstream of the control valve.

8. The manifold assembly of claim 1, wherein the flow detection switch is a vane-type flow detection switch.

9. A manifold assembly mountable to a piping manifold for a dry sprinkler system having a non-wet valve assembly separating pressurized gas on a downstream side thereof from a water supply on an upstream side thereof, the manifold assembly comprising:
a control valve assembly for fluidly connecting with an upstream wet standpipe;
a body having an inlet for removably coupling to, and receiving water from, the control valve assembly, and an outlet for removably coupling to, and delivering water to, the non-wet valve assembly;
a mechanically independent flow detection switch mounted to the body; and
a test and drain valve and a pressure relief valve, each coupled to the valve body downstream from the flow detection switch.

10. The manifold assembly of claim 9, wherein the control valve assembly comprises a butterfly control valve within the body having an endless seal and an operatively associated butterfly valve disk, the butterfly valve disk being rotatable about an axis extending generally perpendicular to water flowing from the inlet to the outlet of the body between a closed position, substantially preventing fluid flow through the body, and an open position, permitting fluid flow through the body.

11. The manifold assembly of claim 10, further comprising a valve actuation assembly having a hand wheel operatively connected with the butterfly valve disk via a control arm.

12. The manifold assembly of claim 9, wherein the test and drain valve and the pressure relief valve are combined into a single module.

13. The manifold assembly of claim 9, wherein the body comprises a spool pipe.

14. The manifold assembly of claim 9, wherein the flow detection switch is a vane-type flow detection switch.

15. A non-wet valve assembly mountable to a piping manifold for a dry sprinkler system, between pressurized gas on a downstream side thereof and water supply on an upstream side thereof, the non-wet valve assembly comprising:
a throat defining a monolithic extension of an upstream side of the non-wet valve assembly, the throat having an inlet for removably coupling to, and receiving water from, a control valve assembly;
a mechanically independent flow detection switch mounted to the throat; and
a test and drain valve and a pressure relief valve, each coupled to the throat downstream from the flow detection switch.

16. The non-wet valve assembly of claim 15, wherein the test and drain valve and the pressure relief valve are combined into a single module.

17. The non-wet valve assembly of claim 15, where the flow detection switch is a vane-type flow detection switch.
